(19) United States
(12) Patent Application Publication
(10) Pub. No.: US 2016/0252781 A1
(43) Pub. Date: Sep. 1, 2016

(54) PIXEL ELECTRODE LAYER, ARRAY SUBSTRATE, AND DISPLAY PANEL

(71) Applicant: SHENZHEN CHINA STAR OPTOELECTRONICS TECHNOLOGY CO., LTD., Shenzhen, Guangdong (CN)

(72) Inventor: Li CHAI, Shenzhen, Guangdong (CN)

(73) Assignee: Shenzhen China Star Optoelectronics Technology Co., Ltd., Shenzhen, Guangdong (CN)

(21) Appl. No.: 14/423,661

(22) PCT Filed: Nov. 28, 2014
(86) PCT No.: PCT/CN2014/092430

§ 371 Date: Feb. 24, 2015

(30) Foreign Application Priority Data
Oct. 28, 2014 (CN) 201410588307.8

(51) Int. Cl. G02F 1/1343; G02F 1/1362; G02F 1/1368; G02F 1/1333

(52) U.S. Cl. CPC G02F 1/134309; G02F 1/133345; G02F 1/136286; G02F 1/1368; G02F 1/133377; G02F 2201/123

(57) ABSTRACT

Disclosed is a pixel electrode layer. The pixel electrode layer is a transparent or semitransparent film. The pixel electrode layer includes a plurality of circular holes formed therein. The plurality of circular holes causes liquid crystal molecules to distribute and orient in a circular form so as to achieve an effect of full view angle. Also disclosed are an array substrate and a display panel.

### CROSS REFERENCE TO RELATED APPLICATIONS

This application claims the priority of Chinese Patent Application No. 201410588307.8, entitled “Pixel Electrode Layer, Array Substrate, and Display Panel”, filed on Oct. 28, 2014, the disclosure of which is incorporated herein by reference in its entirety.

### BACKGROUND OF THE INVENTION

1. Field of the Invention

The present invention relates to the field of liquid crystal displaying, and in particular to a pixel electrode layer, an array substrate, and a display device.

2. The Related Arts

The maturation of the optoelectronic technology and the manufacture technology of semiconductor brings the vivid development of flat panel displays. Due to various advantages, such as low operation voltage, no spread of radioactive rays, reduced weight, and small size, liquid crystal displays have taken the place of the traditional cathode ray tube (CRT) displays and become the main stream of display device products recently. However, the liquid crystal displays suffer issues of limited view angles. Thus, it becomes one of the goals to be achieved by the developers and the researches to develop a display panel of a liquid crystal display having improved displaying effect and a widened view angle.

### SUMMARY OF THE INVENTION

A technical issue to be addressed in the present invention is to provide a pixel electrode layer, an array substrate, and a display panel that achieve full view angle displaying

To achieve the above object, the present invention provides the following technical solutions:

In one aspect, the present invention provides a pixel electrode layer. The pixel electrode layer is a transparent or semitransparent film. The pixel electrode layer comprises a plurality of circular holes formed therein, wherein the plurality of circular holes cause liquid crystal molecules to distribute and orient in a circular form so as to achieve an effect of full view angle.

In the above pixel electrode layer, the plurality of circular holes is arranged in a rectangular array comprising multiple rows and multiple columns distributed on the pixel electrode layer.

In the above pixel electrode layer, the plurality of circular holes is alternatively arranged in a circular array comprising multiple circles distributed on the pixel electrode layer.

In the above pixel electrode layer, the circular holes have a diameter in the range of 2 um to 3.5 um.

In the above pixel electrode layer, edges of two adjacent ones of the circular holes that are close to each other are spaced by a distance in the range of 2.5 um to 5 um.

In another aspect, the present invention provides an array substrate, which comprises the pixel electrode layer as described in any of the above paragraphs.

In the above array substrate, the array substrate further comprises a passivation layer and an insulation layer, and the passivation layer is stacked between the pixel electrode layer and the insulation layer.

In the above array substrate, the array substrate further comprises a scan line, a data line, and a thin-film transistor, and the thin-film transistor is electrically connected to the scan line, the data line, and the pixel electrode layer.

In the above array substrate, the scan line and the data line are arranged to respectively extend along adjacent edges of the pixel electrode layer and the thin-film transistor is set close to a corner of the pixel electrode layer.

In a further aspect, the present invention provides a display panel, which comprises the array substrate as described in any of the above paragraphs.

The present invention provides a pixel electrode layer that comprises a plurality of circular holes formed therein so that the plurality of circular holes causes liquid crystal molecules to distribute and orient in a circular form to achieve an effect of full view angle. Further, the arrangement of the circular holes that helps achieve full view angle has the advantages of simple structure and low cost.

### BRIEF DESCRIPTION OF THE DRAWINGS

To more clearly illustrate the technical solutions proposed in the present invention, a brief description of the drawings that are necessary for describing embodiments of the present invention is given below. It is obvious that the drawings that will be described below show only some embodiments of the present invention and for those having ordinary skills of the art, other drawings may also be readily available from these attached drawings without the expense of creative effort and endeavor.

FIG. 1 is a schematic view showing a pixel electrode layer according to an embodiment of the present invention;

FIG. 2 is a schematic view showing an array substrate according to an embodiment of the present invention; and

FIG. 3 is cross-sectional view taken along the line marked III in FIG. 2.

### DETAILED DESCRIPTION OF THE PREFERRED EMBODIMENTS

A clear and complete description will be given to technical solutions of the embodiments of the present invention with reference to the attached drawings of the embodiments of the present invention.

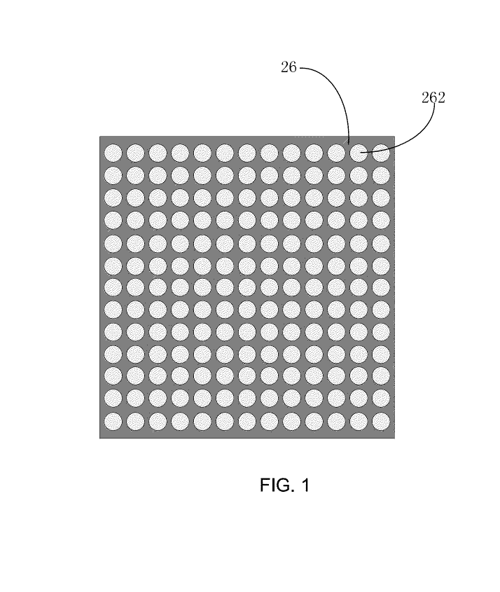

Referring to FIG. 1, the present invention provides a pixel electrode layer 26. The pixel electrode layer 26 is transparent or semitransparent film. The pixel electrode layer 26 comprises a plurality of circular holes 262 formed therein and the plurality of circular holes 262 causes liquid crystal molecules to be distributed and oriented in a circular form so as to achieve an effect of full view angle.

The present invention is structured in such a way that the pixel electrode layer 26 is provided with a plurality of circular holes 262 formed therein so that the plurality of circular holes 262 makes liquid crystal molecules distributed and oriented in a circular form to achieve an effect of full view angle. Further, the arrangement of the circular holes 262 that helps achieve full view angle has the advantages of simple structure and low cost.

Specifically, the arrangement of the plurality of circular holes 262 is not limited to any specific form. In one embodiment, the plurality of circular holes 262 is arranged to form a rectangular array comprising multiple rows and columns distributed on the pixel electrode layer 26. In an alternative embodiment, the plurality of circular holes 262 is arranged to form a circular array comprising multiple circles distributed on the pixel electrode layer 26. In other embodiments, the plurality of circular holes 262 can be arranged in various forms or simple a random distribution without any specific order of distribution.

In a preferred embodiment of the present invention, the circular holes 262 are uniformly distributed on the pixel electrode layer 26 in order to enhance, on the basis of full view angle, the performance of displaying.

In the instant embodiment, the circular holes 262 have a diameter in the range of 2 um to 3.5 um.

The edges of two adjacent ones of the circular holes 262 that are close toe ach other are spaced by a distance in the range of 2.5 um to 5 um.

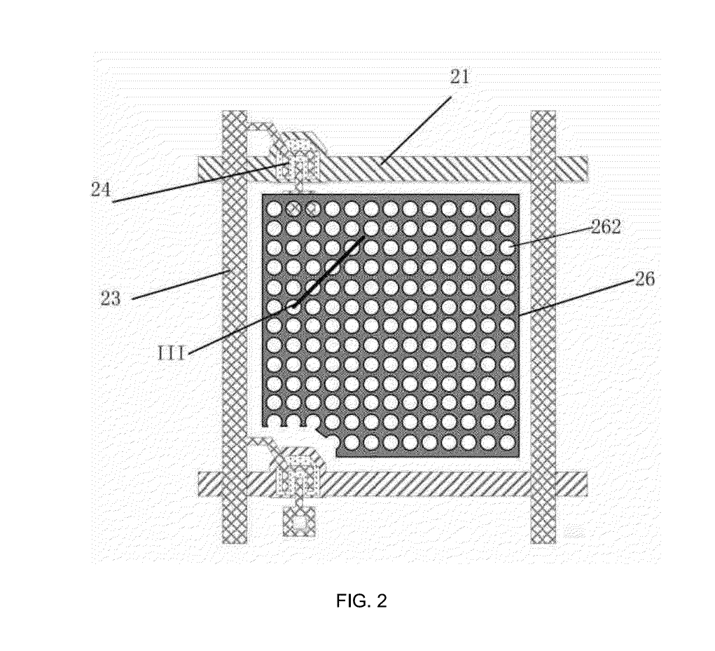

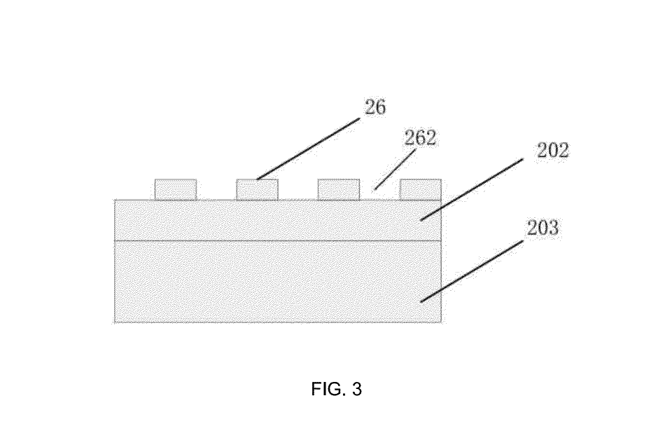

The present invention also provides an array substrate. As shown in FIGS. 2 and 3, the array substrate comprises the pixel electrode layer 26 provided by the present invention.

Specifically, as shown in FIG. 3, the array substrate further comprises a passivation layer 202 and an insulation layer 203. The passivation layer 202 is arranged to stack between the pixel electrode layer 26 and the insulation layer 203. The array substrate further comprises a scan line 21, a data line 23, and a thin-film transistor 24. The thin-film transistor 24 is electrically connected to the scan line 21, the data line 23, and the pixel electrode layer 26. The scan line 21 and the data line 23 are arranged to respectively extend along two adjacent edges of the pixel electrode layer 26. The thin-film transistor 24 is set close to a corner of the pixel electrode layer 26.

The present invention further provides a display panel, which comprises the array substrate.

Disclosed above are only the preferred embodiments of the present invention. It is appreciated that those having ordinary skills of the art may readily appreciate various improvements and modifications without departing from the principle of the present invention and these improvements and modifications are considered within the protection scope of the present invention.

What is claimed is:

1. A pixel electrode layer, which is a transparent or semitransparent film, the pixel electrode layer comprising a plurality of circular holes formed therein, wherein the plurality of circular holes cause liquid crystal molecules to distribute and orient in a circular form so as to achieve an effect of full view angle.

2. The pixel electrode layer as claimed in claim 1, wherein the plurality of circular holes is arranged in a rectangular array comprising multiple rows and multiple columns distributed on the pixel electrode layer.

3. The pixel electrode layer as claimed in claim 1, wherein the plurality of circular holes is arranged in a circular array comprising multiple circles distributed on the pixel electrode layer.

4. The pixel electrode layer as claimed in claim 1, wherein the circular holes have a diameter in the range of 2 um to 3.5 um.

5. The pixel electrode layer as claimed in claim 1, wherein edges of two adjacent ones of the circular holes that are close to each other are spaced by a distance in the range of 2.5 um to 5 um.

6. An array substrate, which comprises the pixel electrode layer as claimed in claim 1.

7. The array substrate as claimed in claim 6, wherein the array substrate further comprises a passivation layer and an insulation layer, the passivation layer being stacked between the pixel electrode layer and the insulation layer.

8. The array substrate as claimed in claim 7, wherein the array substrate further comprises a scan line, a data line, and a thin-film transistor, the thin-film transistor being electrically connected to the scan line, the data line, and the pixel electrode layer.

9. The array substrate as claimed in claim 8, wherein the scan line and the data line are arranged to respectively extend along adjacent edges of the pixel electrode layer and the thin-film transistor is set close to a corner of the pixel electrode layer.

10. The array substrate as claimed in claim 8, wherein the plurality of circular holes is arranged in a rectangular array comprising multiple rows and multiple columns distributed on the pixel electrode layer.

11. The array substrate as claimed in claim 8, wherein the plurality of circular holes is arranged in a circular array comprising multiple circles distributed on the pixel electrode layer.

12. The array substrate as claimed in claim 8, wherein the circular holes have a diameter in the range of 2 um to 3.5 um.

13. The array substrate as claimed in claim 8, wherein edges of two adjacent ones of the circular holes that are close to each other are spaced by a distance in the range of 2.5 um to 5 um.

14. A display panel, which comprises the array substrate as claimed in claim 6.

15. The display panel as claimed in claim 14, wherein the array substrate further comprises a passivation layer and an insulation layer, the passivation layer being stacked between the pixel electrode layer and the insulation layer.

16. The display panel as claimed in claim 15, wherein the array substrate further comprises a scan line, a data line, and a thin-film transistor, the thin-film transistor being electrically connected to the scan line, the data line, and the pixel electrode layer.

17. The display panel as claimed in claim 16, wherein the scan line and the data line are arranged to respectively extend along adjacent edges of the pixel electrode layer and the thin-film transistor is set close to a corner of the pixel electrode layer.

18. The display panel as claimed in claim 17, wherein the plurality of circular holes is arranged in a rectangular array comprising multiple rows and multiple columns or a circular array comprising multiple circles distributed on the pixel electrode layer.

19. The display panel as claimed in claim 17, wherein the circular holes have a diameter in the range of 2 um to 3.5 um.

20. The display panel as claimed in claim 17, wherein edges of two adjacent ones of the circular holes that are close to each other are spaced by a distance in the range of 2.5 um to 5 um.
